(19) United States
(12) Patent Application Publication
(10) Pub. No.: US 2004/0231902 A1
(43) Pub. Date: Nov. 25, 2004

(54) Arrangement at picking truck

(76) Inventors: Magnus Carlson, Vikingstad (SE); Sven-Erik Wernborg, Mjolby (SE); Cecilia Svartling, Mjolby (SE)

Correspondence Address: HAYES, SOLOWAY P.C., 130 W. CUSHING STREET, TUCSON, AZ, 85701, US

(21) Appl. No.: 10/841,108

(22) Filed: May 7, 2004

(30) Foreign Application Priority Data
May 8, 2003 (SE) 0301345-5

(51) Int. Cl. B60K 31/00

(52) U.S. Cl. 180/170

(57) ABSTRACT

Picking truck with a travel platform or the like for the driver, which truck is provided with a sensor for detecting if the driver is on the platform or not and a sensor for the steering angle. The truck allows driving also when the driver does not stand on the platform, but when the driver has stepped down from the platform the maximum permitted travel speed depends on the steering angle and is reduced in two steps or more or along a graph where the permitted maximum travel speed of the truck is reduced with increasing steering angle. At steering angles over a defined steer angle, for instance 30° and with stepped off driver no travel is permitted.

This invention is related to picking trucks of the kind that includes a platform or the like for the driver to stand on at the travel of the truck. If the places where the merchandize is to be collected are close to each other this either result in several short walks or little short travels of the truck. In order not to necessitate for the driver to climb onto the truck for these short travels it is known to arrange additional controls on the sides of the truck for the moving straight forward of the truck with reduced speed without the driver climbing up on the truck. For instance the available maximum speed is reduced to half the normally available maximum speed. The reason for this is the security aspect since one does not want the driver run into himself or be jammed by his own truck.

Even if the above solution makes the use of trucks of this kind more efficient it has the drawback that the truck before you start a series of movements with the driver walking at the side must be adjusted to be comparatively parallel to the store alley so that the driver does not have to climb up on the truck in order to steer it right alternatively to risk that the available walking space at the side of the truck is constantly reduced thereby giving the driver a space for movement that is too narrow for the driver at the picking, with resulting lack of ergonomics for lifting on and off.

The object of the invention is further to improve the efficiency of picking trucks with a place for the driver to stand. In accordance with the invention this is achieved by the truck in a normal way being provided with sensor means that when the driver leaves his place on the truck initiate a reduction of the maximum available travel speed, for instance half. Different from the known technique steering is still allowed but the maximum travel speed is reduced as a function of the steering movement and when a defined limit angle has been reached no further turning is allowed.

As an alternative to the above instead or additionally the turning speed of the steering is reduced as a function of the steering angle measured from the center position. Preferably also the maximally possible steering angle is reduced. The risks for the driver can in this way be kept small at the same time as the flexibility gets better.

Within the concept of the invention both of the above alternatives can be combined with each other so that both the maximal travel speed and the maximum steering angle speed are limited as a function of the steering angle from the center position. In this way only a very slow movement is allowed laterally, which considerably lessens the risk that the driver is jammed or drives over his own feet by mistake.

The maximum turning speed of the steering movement can be reduced in one step when the driver leaves his place on the truck and/or successively with the steering angle.

In a preferable further development of the inventive thought only a limited steering angle is allowed to each side, for instance 30° and advantageously available maximum travel speed is reduced to zero at the same angle.

Within the inventive thought one could also consider letting maximum steering angle speed and value be a function of the travel speed, so that a lower used travel speed allows a larger turn angle speed and/or a larger maximum steering angle. In this way the manouverablility of the truck is increased without compromising the security. By lowering the used speed a larger steering angel can thus be used more or less temporarily for required course correction.

The reduction of travel speed and/or steering angle speed can be stepwise or along some suitable graph. Advantageously the speed of the truck can be reduced in one step when the driver gets off, for instance halved if the truck a the dismounting had the steering wheel adjusted for movement straight forward and more if steering still takes place at the dismounting.

At the invention advantageously the same steering means are used when the driver is at the side of the truck as well as when he stands on the truck. By letting the truck retain the low maximum travel speed and/or steering angle speed that is used when maneuvering from the side, even if the driver steps up on the truck, until its drive control has been returned to its zero position, jerks are avoided when the driver steps up on the truck from walking and steering beside it.

Through the invention the truck becomes both easier to steer and use and more ergonomic at the same time as the security increase.

1. Picking truck with travel platform or the like for the driver, which truck is provided with a sensor for detecting if the driver is on the platform or not, the truck is arranged to allow driving also when the driver has stepped off, characterized in that the truck is provided with sensor for the steering angle and so arranged that when the driver has stepped down from the platform the maximum permissible travel speed is reduced stepwise in two or several steps along a graph, where the maximum permissible travel speed of the truck is reduced with a steering angle increasing from a center position corresponding to traveling straight forward.

2. Picking truck according to claim 1, characterized in that it is so arranged that the permissible maximum travel speed of the truck with dismounted driver and a steering angle in excess of a defined steering angle, for instance 30° is zero, that is no travel is permitted.

3. Picking truck according to any of the preceding claims, characterized in that it is so arranged that the truck continue with unaltered speed if the driver step up on it when it is already in motion and that some additional measure, for instance that the speed control is returned to its zero position, even if very quickly, is required for returning the truck to the normal drive state when the driver is on the platform.

4. Picking truck with a travel platform or the like for the driver, which truck is arranged with a sensor for detecting if the driver is on the platform or not, which truck is arranged to allow driving also when the driver has stepped down, characterized in that the truck is provided with sensor for the steering angel and so arranged that when the driver has stepped down from the platform the maximally permitted steering angle speed stepwise or along a graph is reduced as a function of increasing steering angle and/or speed.

5. Picking truck according to claim 4, characterized in that it is so arranged that when the driver has stepped off and a defined steering angel has been reached, for instance 30° no larger steering angle is permitted.
